(19) United States
(12) Patent Application Publication
(10) Pub. No.: US 2025/0150705 A1
(43) Pub. Date: May 8, 2025

(54) IMAGE PROCESSING METHOD AND APPARATUS, ELECTRONIC DEVICE, AND STORAGE MEDIUM

(71) Applicant: VIVO MOBILE COMMUNICATION CO., LTD., Dongguan (CN)

(72) Inventors: Liao ZHOU, Dongguan (CN); Haolong GUO, Dongguan (CN)

(73) Assignee: VIVO MOBILE COMMUNICATION CO., LTD., Dongguan (CN)

(21) Appl. No.: 19/014,208

(22) Filed: Jan. 8, 2025

Related U.S. Application Data
(63) Continuation of application No. PCT/CN2023/109158, filed on Jul. 25, 2023.

(30) Foreign Application Priority Data
Jul. 29, 2022 (CN) 202210908193.5

(51) Int. Cl. H04N 23/63; H04N 23/60; H04N 23/67

(52) U.S. Cl. CPC H04N 23/632; H04N 23/64; H04N 23/675

(57) ABSTRACT

This application provides an image processing method and apparatus, an electronic device, and a storage medium. The method includes: displaying a shooting preview image; and updating the shooting preview image by using a target object as a focusing object. The shooting preview image includes a first object and a second object. The first object is a virtual shooting object. The second object is an object in a shooting scene corresponding to the shooting preview image. The target object is the first object or the second object.

### CROSS-REFERENCE TO RELATED APPLICATIONS

This application is a continuation of International Application No. PCT/CN 2023/109158, filed on Jul. 25, 2023, which claims priority to Chinese Patent No. 202210908193.5, filed on Jul. 29, 2022. The entire contents of each of the above-referenced applications are expressly incorporated herein by reference.

### TECHNICAL FIELD

This application pertains to the field of image processing technologies, and specifically, to an image processing method and apparatus, an electronic device, and a storage medium.

### BACKGROUND

An Augmented Reality (AR) technology is a technology that combines real-world information with virtual-world information, that is, a virtual object is placed in an actual scene, so that the fun of users in work and life can be increased and user experience can be improved. With continuous development of the AR technology, shooting applications on electronic devices are increasingly used.

Generally, when using an AR shooting function of a camera application, an electronic device may first capture an image of a real object, and after a virtual object such as a human or an animal is added to the captured image, the electronic device may perform image synthesis on the captured image of the real object and the virtual object to obtain a picture including the image of the real object and the virtual object.

However, in the foregoing method, after the virtual object is added in the image capturing process, a scene composition of the entire image changes, and the captured image of the real object and the virtual object are directly synthesized in the existing method. Consequently, an effect of an image shot by an electronic device in an AR shooting scene is relatively poor.

### SUMMARY

Embodiments of this application provide an image processing method and apparatus, an electronic device, and a storage medium.

According to a first aspect, an embodiment of this application provides an image processing method. The image processing method includes: displaying a shooting preview image, where the shooting preview image includes a first object and a second object, the first object is a virtual shooting object, and the second object is an object in a shooting scene corresponding to the shooting preview image; and updating the shooting preview image by using a target object as a focusing object, where the target object includes one of the following: the first object and the second object.

According to a second aspect, an embodiment of this application provides an image processing apparatus. The image processing apparatus includes a display module and an update module. The display module is configured to display a shooting preview image, where the shooting preview image includes a first object and a second object, the first object is a virtual shooting object, and the second object is an object in a shooting scene corresponding to the shooting preview image. The update module is configured to update the shooting preview image by using a target object as a focusing object, where the target object includes one of the following: the first object and the second object.

According to a third aspect, an embodiment of this application provides an electronic device. The electronic device includes a processor and a memory, the memory stores a program or an instruction that can be run on the processor, and the program or the instruction is executed by the processor to implement the steps of the method according to the first aspect.

According to a fourth aspect, an embodiment of this application provides a readable storage medium. The readable storage medium stores a program or an instruction, and the program or the instruction is executed by a processor to implement the steps of the method according to the first aspect.

According to a fifth aspect, an embodiment of this application provides a chip. The chip includes a processor and a communication interface, the communication interface is coupled to the processor, and the processor is configured to run a program or an instruction to implement the method according to the first aspect.

According to a sixth aspect, an embodiment of this application provides a computer program product. The program product is stored in a storage medium, and the program product is executed by at least one processor to implement the method according to the first aspect.

In the embodiments of this application, an electronic device determines a target object from a first object and a second object, to perform focusing processing on the target object and perform blurring processing on another image area. In this solution, after the first object is added in a shooting scene, the electronic device may select a focusing subject in the shooting scene based on the first object and a preset shooting subject, to re-trigger a focusing and blurring policy so as to generate a better photographing or video effect. That is, after a composition changes due to the addition of the first object, the electronic device performs a refocusing and blurring operation based on a current composition situation, to ensure that an image obtained after the refocusing and blurring operation can meet a shooting requirement of a current scene, so that a focusing or blurring effect of the entire image is improved, thereby improving an effect of shooting an image by the electronic device in an AR shooting scene.

### BRIEF DESCRIPTION OF DRAWINGS

FIG. 1 is a first flowchart of an image processing method according to an embodiment of this application;

FIG. 2 is a second flowchart of an image processing method according to an embodiment of this application;

FIG. 3A-FIG. 3B are schematic diagrams of an example of a preview interface and a virtual object in a default focusing mode according to an embodiment of this application;

FIG. 4 is a third flowchart of an image processing method according to an embodiment of this application;

FIG. 5 is a schematic diagram of an interface example of an actual focusing subject shot in an indoor shooting scene according to an embodiment of this application;

FIG. 6 is a schematic diagram of an interface example in which a virtual object is determined as a focusing subject according to an embodiment of this application;

FIG. 7 is a schematic diagram of an interface example in which an original actual focusing subject is determined as a focusing subject according to an embodiment of this application;

FIG. 8A-FIG. 8B are first schematic diagrams of interface examples of effects before and after refocusing and blurring according to an embodiment of this application;

FIG. 9A-FIG. 9B are second schematic diagrams of interface examples of effects before and after refocusing and blurring according to an embodiment of this application;

FIG. 10A-FIG. 10B are third schematic diagrams of interface examples of effects before and after refocusing and blurring according to an embodiment of this application;

FIG. 11 is a schematic structural diagram of an image processing apparatus according to an embodiment of this application;

FIG. 12 is a first schematic diagram of a hardware structure of an electronic device according to an embodiment of this application; and

FIG. 13 is a second schematic diagram of a hardware structure of an electronic device according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

With reference to the accompanying drawings, the following describes in detail an image processing method provided in the embodiments of this application by using specific embodiments and application scenes thereof.

A virtual object is placed in an actual scene, so as to increase the fun of users in work and life and improve user experience, and the like. When a camera AR function works, after a virtual object such as a human or an animal is added, an original policy is maintained, and refocusing or blurring is not performed on a scene composition change brought by the virtual object. As a result, a resulting scene effect is not ideal.

After a first object is added in a shooting scene, an electronic device may select a focusing subject in the shooting scene based on the first object and a preset shooting subject, to re-trigger a focusing and blurring policy so as to generate a better photographing or video effect. That is, after a composition changes due to the addition of the first object, the electronic device performs a refocusing and blurring operation based on a current composition situation, to ensure that an image obtained after the refocusing and blurring operation can meet a shooting requirement of a current scene, so that a focusing or blurring effect of the entire image is improved, thereby improving an effect of shooting an image by the electronic device in an AR shooting scene.

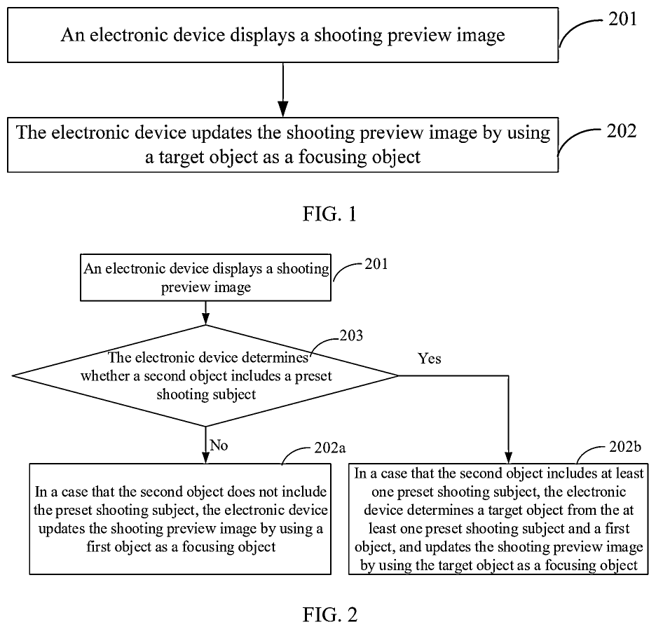

An embodiment of this application provides an image processing method. FIG. 1 is a flowchart of an image processing method according to an embodiment of this application. The method may be applied to an electronic device. As shown in FIG. 1, the graphics processing method provided in this embodiment of this application may include the following step 201 and step 202.
Step 201: An electronic device displays a shooting preview image.

In this embodiment of this application, the shooting preview image includes a first object and a second object. The first object is a virtual shooting object, and the second object is an object in a shooting scene corresponding to the shooting preview image.

In this embodiment of this application, after a camera function is enabled on the electronic device, a shooting preview interface may be displayed, the shooting preview image is captured by using the camera, and the shooting preview image is displayed on the shooting preview interface, where the shooting preview image includes the second object. After the user adds the first object, the electronic device may display the first object on the shooting preview interface. In this case, the shooting preview image includes the first object and the second object.

For example, in this embodiment of this application, the first object and the second object may include but are not limited to at least one of the following: a human object, an animal object, another category object (for example, an object such as a building, a flower, or a tree). For example, this may be determined based on an actual use requirement, and is not limited in this embodiment of this application.

It should be noted that the second object may be understood as an object captured by the camera of the electronic device in an actual shooting scene. The first object may be understood as one or more virtual objects projected in an actual scene/actual scene by using an AR technology.
Step 202: The electronic device updates the shooting preview image by using a target object as a focusing object.

In this embodiment of this application, the target object includes one of the following: the first object and the second object.

In this embodiment of this application, the electronic device may compare saliency of all objects in the shooting preview image to select an object with the highest saliency from the target object, that is, select an object with the highest saliency from the first object and the second object as a focusing object, and use the focusing object as a subject object to be focused, so as to focus the subject object.

For example, in this embodiment of this application, the foregoing saliency may be any one of the following: a saliency of each object in the shooting preview image, and a weight size of feature information (for example, a category or a location) of each object.

In this embodiment of this application, after a first object is added in a shooting scene, an electronic device may select a focusing subject in the shooting scene based on the first object and a preset shooting subject, to re-trigger a focusing and blurring policy so as to generate a better photographing or video effect. That is, after a composition changes due to the addition of the first object, the electronic device performs a refocusing and blurring operation based on a current composition situation, to ensure that an image obtained after the refocusing and blurring operation can meet a shooting requirement of a current scene, so that a focusing or blurring effect of the entire image is improved, thereby improving an effect of shooting an image by the electronic device in an AR shooting scene.

For example, in this embodiment of this application, with reference to FIG. 1, as shown in FIG. 2, before the “electronic device uses a target object as a focusing object” in step 202, the image processing method provided in this embodiment of this application further includes the following step 203, and the foregoing step 202 may be implemented by step 202a or step 202b.
Step 203: The electronic device determines whether the second object includes a preset shooting subject.
Step 202a: In a case that the second object does not include the preset shooting subject, the electronic device updates the shooting preview image by using the first object as a focusing object.

It may be understood that when the second object does not include the preset shooting subject, the electronic device may determine the first object as the target object, that is, a subject object to be focused. In a case that a saliency of all shooting objects in the second object is less than a threshold, or a difference between all shooting objects in the second object is less than a threshold, the electronic device determines that no focusing object exists in the second object.

For example, in this embodiment of this application, the preset shooting subject is not limited to at least one of the following: a human object, an animal object, another category object (for example, an object such as a building, a flower, or a tree). For example, this may be determined based on an actual use requirement, and is not limited in this embodiment of this application.

For example, in this embodiment of this application, in a default focusing mode, in a case that the second object does not include the preset shooting subject, the electronic device may update the shooting preview image by using the first object as a focusing object.

It should be noted that the default focusing mode may be understood as a default shooting mode in a system of the electronic device after a camera function is enabled on the electronic device. In this shooting mode, the electronic device may automatically perform focusing and blurring based on a shooting object.

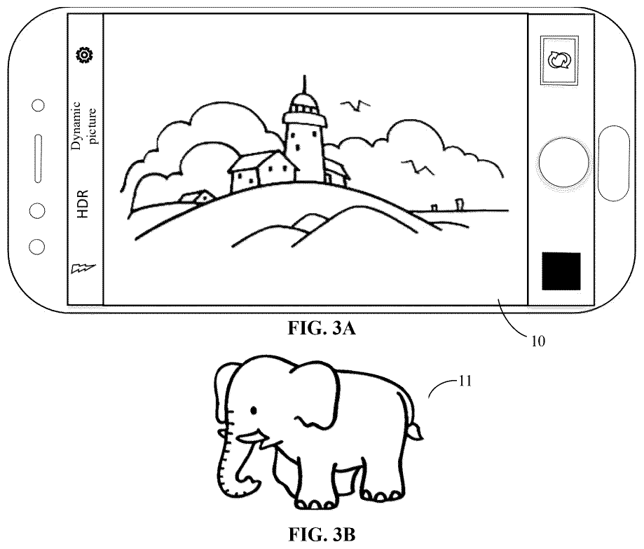

For example, in the default focusing mode, as shown in FIG. 3A, the electronic device displays a preview interface 10, where the preview interface 10 includes an image captured by the camera of the electronic device, and the image includes the second object. The electronic device detects that no actual focusing object exists in the second object. Therefore, the electronic device may determine the newly added first object shown in FIG. 3B as the target object, so as to perform focusing processing on the target object.
Step 202b: In a case that the second object includes at least one preset shooting subject, the electronic device determines the target object from the at least one preset shooting subject and the first object, and updates the shooting preview image by using the target object as a focusing object.

In this embodiment of this application, in a case that the second object includes the at least one preset shooting subject, the electronic device may determine an object with the largest feature weight in the at least one preset shooting subject and the first object as a focusing object, that is, a subject object to be focused.

For example, in this embodiment of this application, the electronic device may determine, as the target object, an object whose saliency is greater than a threshold in the at least one preset shooting subject and the first object, or an object whose saliency difference from another object is greater than a threshold object.

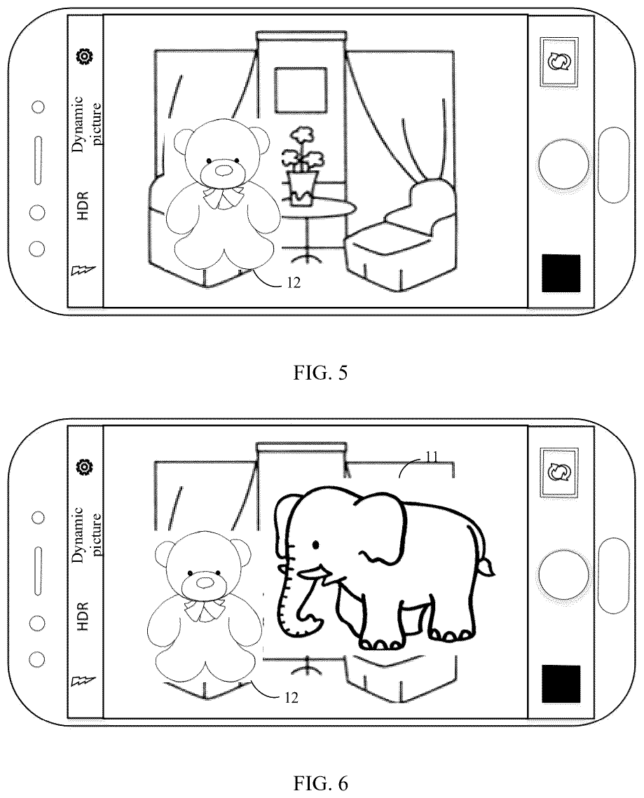

For example, as shown in FIG. 5, the electronic device is in an indoor shooting scene, and the preset shooting subject in the shooting scene is a doll bear 12. After the first object is added, the electronic device may determine a new focusing object by comparing a category, a location, a size, and a distance of the first object from the camera with those of the doll bear 12 in the shooting scene.

In this embodiment of this application, in the default focusing mode, the electronic device may determine whether the preset shooting subject exists in the second object to determine a focusing object, so that when the preset shooting subject does not exist, the first object is determined as a focusing object to perform focusing processing. When the at least one preset shooting subject exists, a focusing object is determined based on feature weights of the preset shooting subject and the first object. Therefore, accuracy of determining the focusing object is improved, and it is ensured that the determined focusing object more conforms to the current shooting scene.

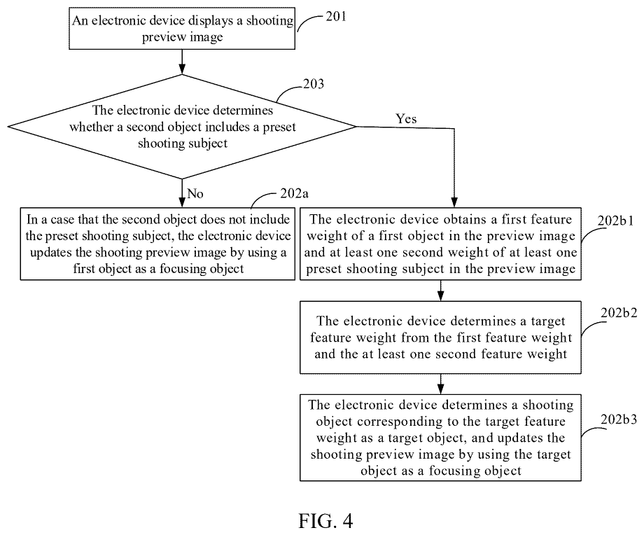

For example, in this embodiment of this application, with reference to FIG. 2, as shown in FIG. 4, the foregoing step 202b may be implemented by the following steps 202b1 to 202b3.
Step 202b1: The electronic device obtains a first feature weight of the first object in the preview image and at least one second feature weight of the at least one preset shooting subject in the preview image.

The feature weight (for example, the first feature weight, the second feature weight, or a target feature weight) in this embodiment of this application is used to indicate shooting saliency of a shooting object in the preview image.

For example, in this embodiment of this application, in the default focusing mode, the electronic device may calculate the preset shooting subject of the current shooting scene based on information about the current shooting scene, to complete initial focusing. In addition, the electronic device may record second feature information of the preset shooting subject in the shooting scene in this case.

For example, in this embodiment of this application, the second feature information includes at least one of the following: location information of the preset shooting subject in the shooting scene, a screen size of the preset shooting subject in the shooting scene, a distance between the preset shooting subject and the camera, and category information of the preset shooting subject.

For example, in this embodiment of this application, in the default focusing mode, the electronic device may obtain the second feature information of the preset shooting subject in the current shooting scene by using a virtual object generation algorithm or a 3D measurement algorithm, for example, a Simultaneous Localization and Mapping (SLAM) algorithm or a Time of Flight (TOF) algorithm, or by using a method such as Phase Detection Auto Focus (PDAF) or Contrast Detection Auto Focus (CDAF).

For example, in this embodiment of this application, feature information of the first object (hereinafter referred to as first feature information) may include at least one of the following: a screen size of the first object in the shooting scene, category information of the first object, location information of the first object in the shooting scene, and a distance between the first object and the camera. The screen size of the first object in the shooting scene and the category information of the first object are obtained by the electronic device by using a virtual object generation algorithm. The location information of the first object in the shooting scene and the distance between the first object and the camera are obtained by the electronic device by using a 3D measurement algorithm.

In this embodiment of this application, the electronic device may assign at least one weight value to the first object based on the first feature information, that is, based on at least one of the category information of the first object, the location information in the shooting scene, the screen size in the shooting scene, and the distance from the camera, where each weight value corresponds to one piece of information in the first feature information, so as to obtain a final weight of the first object, that is, the first feature weight. Similarly, a method for determining the second feature weight of each of the at least one preset shooting subject is similar to the method for determining the first feature weight, and details are not described herein again.

For example, in this embodiment of this application, the electronic device may perform variance calculation on the at least one weight value to obtain the first feature weight. In some embodiments, the electronic device may use a weight value of information with the highest degree of importance as the first feature weight based on a degree of importance of each piece of information in the first feature information.

For example, in this embodiment of this application, after the first object is added, the electronic device may calculate feature weights of the at least one preset shooting subject and the first object based on the following principle, that is, separately obtain final weights of the at least one preset shooting subject and the first object, so as to use an object with the largest weight as the target object.
(1) Weight of the category: Human>Animal>Other categories (weights of building, flower, tree, and the like are equal).
(2) Weight of the location in the shooting scene: Based on a distance from the center of the scene, a closer distance to the center indicates a larger weight, and a farther distance to the center indicates a smaller weight.
(3) Weight of the screen size in the shooting scene: A larger screen size proportion indicates a larger weight, and a smaller screen size occupation ratio indicates a smaller weight.
(4) Weight of the distance from the camera: A closer distance to the camera indicates a larger weight, and a farther distance to the camera indicates a smaller weight.
Step 202b2: The electronic device determines a target feature weight from the first feature weight and the at least one second feature weight.

In this embodiment of this application, the target weight is not less than the first feature weight and the at least one second feature weight.

For example, in this embodiment of this application, the target weight is a maximum weight value of the first feature weight and the at least one second feature weight.
Step 202b3: The electronic device determines a shooting object corresponding to the target feature weight as the target object, and updates the shooting preview image by using the target object as a focusing object.

For example, with reference to FIG. 5, as shown in FIG. 6, after the first object Elephant 11 is added, the first object is located in an area close to the middle location of the screen. The electronic device may determine, by comparing a location, a size, and a distance of the first object from the camera with those of the at least one preset shooting subject (for example, the doll bear 12), that a new focusing object is an object close to the middle location of the screen, and the object is the first object.

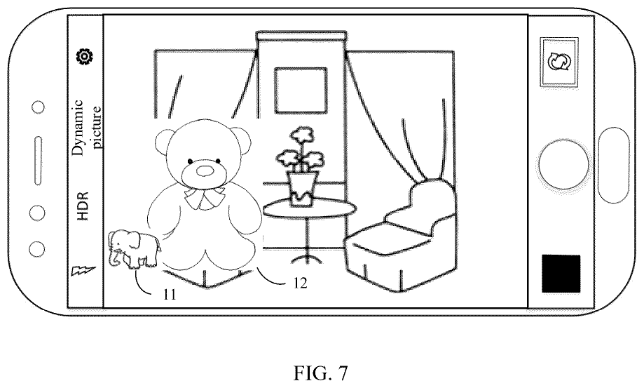

For another example, with reference to FIG. 5, as shown in FIG. 7, after the first object Elephant 11 is added, the first object is located in a lower left corner of the screen, and a proportion of the first object on the screen is smaller than a proportion of the at least one preset shooting subject on the screen. The electronic device may determine, by comparing a location, a size, and a distance of the first object from the camera with those of the at least one preset shooting subject, that the focusing object is still the original at least one preset shooting subject Doll bear 12.

In this embodiment of this application, the electronic device may determine feature weights of these objects based on the feature information of the at least one preset shooting subject and the first object, to determine whether to continue to keep the original at least one preset shooting subject unchanged or use the first object as a new focusing object, so as to ensure accuracy of the determined focusing object, thereby ensuring that the determined focusing object more conforms to the current shooting scene.

For example, in this embodiment of this application, the foregoing step 202 may be implemented by the following step 301.
Step 301: The electronic device performs image processing on the shooting preview image by using the target object as a focusing object, to obtain the processed shooting preview image.

For example, in this embodiment of this application, in the default focusing mode, the electronic device may determine the target object based on a comparison result of the first feature weight and the second feature weight, and re-trigger a focusing algorithm and a blurring algorithm. The electronic device may perform focusing processing based on location coordinate information of the target object, and then perform blurring processing on front and rear depth of fields, so as to highlight an effect of the focusing object, thereby improving a graphic effect.

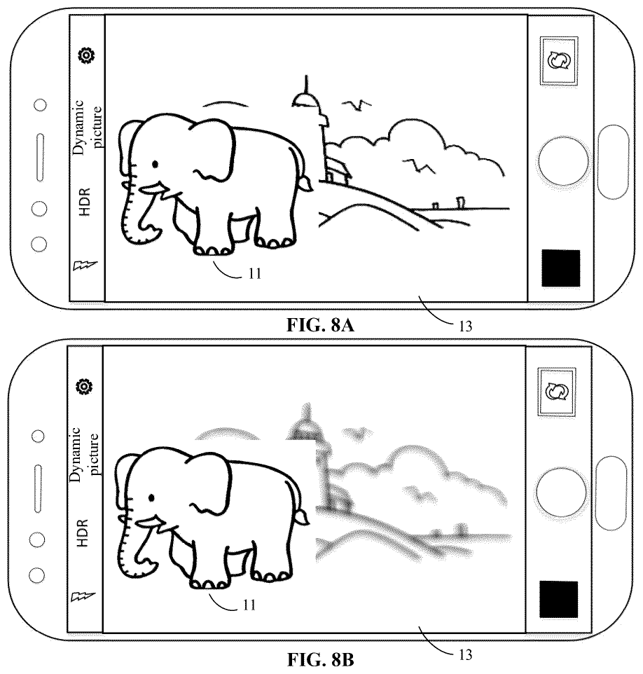

For example, as shown in FIG. 8A, the electronic device displays a preview interface 13 in the default focusing mode. The preview interface 13 includes the second object, but there is no preset shooting subject in the second object. After the first object Elephant 11 is added, the electronic device may display the first object and the second object on the preview interface 13. As shown in FIG. 8B, the electronic device determines that there is no preset shooting subject in a shooting object on the preview interface 13, that is, the second object on the preview interface 13 is not a preset shooting object. In this case, the electronic device may determine the first object as the target object, re-trigger focusing and blurring algorithms to perform focusing processing on the target object, and then perform blurring processing on an image area other than the target object on the preview interface 13. It may be understood that FIG. 8A is an image effect before the refocusing and blurring, and FIG. 8B is an image effect after the refocusing and blurring. After the refocusing and blurring, a significant object in the shooting scene can be highlighted.

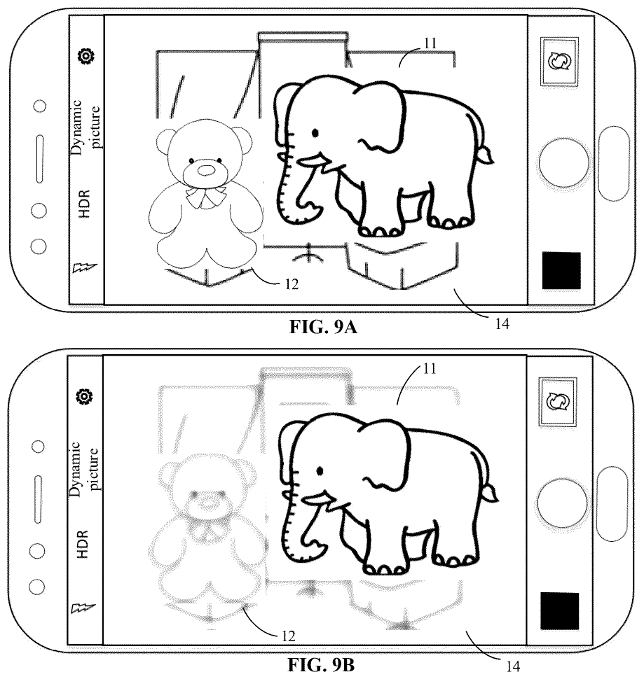

For another example, as shown in FIG. 9A, the electronic device displays a preview interface 14 in the default focusing mode. The preview interface 14 includes the second object, and there is a preset shooting subject in the second object. After the first object is added, the electronic device may display the first object and the second object on the preview interface 14. As shown in FIG. 9B, the electronic device determines that there is a preset shooting subject in a shooting object on the preview interface 14, for example, Doll bear 12. In this case, the electronic device may determine, by comparing a location, a screen size, and a distance of the first object from the camera with those of the preset shooting subject, that an object closer to the camera is the target object. That is, the electronic device may determine Elephant 11 on the preview interface 14 as the target object, re-trigger focusing and blurring algorithms to perform focusing processing on the target object, and then perform blurring processing on an image area other than the target object on the preview interface 14. It may be understood that FIG. 9A is an image effect before the refocusing and blurring, and FIG. 9B is an image effect after the refocusing and blurring. After the refocusing and blurring, saliency of the first object in the shooting scene can be clearly highlighted.

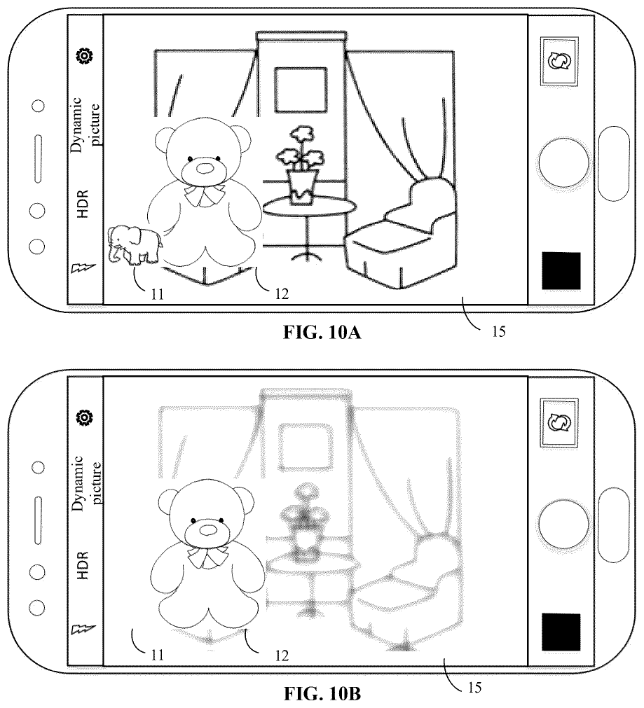

For another example, as shown in FIG. 10A, the electronic device displays a preview interface 15 in the default focusing mode. The preview interface 15 includes the second object, and there is a preset shooting subject in the second object. After the first object is added, the electronic device may display the first object and the second object on the preview interface 15. As shown in FIG. 10B, the electronic device determines that there is a preset shooting subject in a shooting object on the preview interface 15, for example, Doll bear 12. In this case, the electronic device may determine, by comparing a location, a screen size, and a distance of the first object from the camera with those of the preset shooting subject, that an object with a larger screen and closer to a middle location is the target object. That is, the electronic device may determine Doll bear 12 on the preview interface 15 as the target object, re-trigger focusing and blurring algorithms to perform focusing processing on the target object, and then perform blurring processing on an image area other than the target object on the preview interface 15. It may be understood that FIG. 10A is an image effect before the refocusing and blurring, and FIG. 10B is an image effect after the refocusing and blurring. After the refocusing and blurring, saliency of a focusing object can be maintained, so that a focusing object in the shooting scene is clearly highlighted.

For example, in this embodiment of this application, in a virtual object motion focusing mode, the electronic device may determine a saliency degree of the first object based on a quantity and feature information of the first object, use the first object with the highest saliency degree as a focusing object, and perform refocusing and blurring by tracking a motion location change of the first object in real time, thereby highlighting saliency of the first object in the shooting scene, and improving a focusing or blurring effect of the image.

This embodiment of this application provides an image processing method. After a first object is added in a shooting scene, an electronic device may select a focusing subject in the shooting scene based on the first object and a preset shooting subject, to re-trigger a focusing and blurring policy so as to generate a better photographing or video effect. That is, after a composition changes due to the addition of the first object, the electronic device performs a refocusing and blurring operation based on a current composition situation, to ensure that an image obtained after the refocusing and blurring operation can meet a shooting requirement of a current scene, so that a focusing or blurring effect of the entire image is improved, thereby improving an effect of shooting an image by the electronic device in an AR shooting scene.

For example, in this embodiment of this application, the foregoing step 301 may be implemented by the following step 301a.
Step 301a: The electronic device performs first image processing on the shooting preview image based on spatial location information of the target object and by using the target object as a focusing object, to obtain the processed shooting preview image.

In this embodiment of this application, in a virtual object motion focusing mode, the electronic device may obtain the spatial location information of the target object such as spatial coordinates by using a 3D measurement technology, and control a motor to implement first image processing on the target object. In addition, the electronic device may record feature information of the target object in the shooting scene at this time.

For example, in this embodiment of this application, the feature information of the target object in the shooting scene includes at least one of the following types of feature information: a size of the target object, a color of the target object, brightness of the target object, and the like.

In this embodiment of this application, the electronic device may obtain and record the spatial location information of the target object to determine the target object as a focusing object, to ensure accuracy of the determined focusing object, so as to perform image processing on the shooting preview image, thereby ensuring that the determined focusing object more conforms to the current shooting preview image.

For example, in this embodiment of this application, the foregoing step 301 may be implemented by the following step 301b and step 301c.
Step 301b: In a case that the target object moves, the electronic device determines a plane location of the target object based on feature information of the target object in the shooting scene and feature information of a shooting object in the shooting preview image.

In this embodiment of this application, the shooting object may be the second object.

In this embodiment of this application, in a virtual object motion focusing mode, the electronic device may determine the plane location of the target object based on the feature information of the target object in the shooting scene, that is, by matching all detected objects by using a Scale-invariant Feature Transform (SIFT) matching algorithm based on at least one of the size, the color, and the brightness of the target object. The SIFT feature matching algorithm may keep an object unchanged after operations such as rotation, scaling, and brightness change.
Step 301c: The electronic device performs second image processing on the shooting preview image based on the plane location of the target object and first distance information and by using the target object as a focusing object, to obtain the processed shooting preview image.

In this embodiment of this application, the first distance information is a distance between a spatial location corresponding to the target object and the camera.

For example, in this embodiment of this application, the electronic device may obtain the first distance information by using a 3D measurement technology, and control a motor to perform second image processing on the shooting preview image. The electronic device obtains a location of the first object by means of real-time tracking, and performs refocusing processing on the target object, thereby highlighting saliency in the shooting scene and improving an image shooting effect of the electronic device in an AR shooting scene.

For example, in an implementation of this embodiment of this application, the target object is the first object. The foregoing step 202 may be implemented by the following step 202c.
Step 202c: In a case that the first object moves, the electronic device performs motion focusing on the first object, and updates the shooting preview image.

For example, in this embodiment of this application, in a virtual object motion focusing mode, in a case that the first object moves, the electronic device may perform motion focusing on the first object, and update the shooting preview image.

It should be noted that the virtual object motion focusing mode may be understood as follows: The electronic device uses a virtual object as a focusing subject object, and performs focusing and blurring operations based on a motion location change of the virtual object.

For example, in another implementation of this embodiment of this application, the target object is the first object, and the first object includes a first virtual object and a second virtual object. The foregoing step 202 may be implemented by the following step 202d.
Step 202d: In a case that a feature weight of the first virtual object is greater than a feature weight of the second virtual object, the electronic device performs motion focusing on the first virtual object, and updates the shooting preview image.

In this embodiment of this application, the feature weight is used to indicate shooting saliency of a shooting object in the preview image.

For example, in this embodiment of this application, if the first object includes the first virtual object and the second virtual object, the electronic device may obtain feature information of the first virtual object and the second virtual object through target/semantic detection and by using a 3D measurement (for example, SLAM or TOF) technology, and selects the most significant virtual object based on the feature information of the first virtual object and the second virtual object, that is, a virtual object with the largest feature weight is used as the target object for motion focusing.

For example, in this embodiment of this application, the feature information includes at least one of category information, a screen size in the shooting scene, location information in the shooting scene, and a distance from the camera.

For example, in this embodiment of this application, after the foregoing step 202, the image processing method provided in this embodiment of this application further includes the following step 401 and step 402.
Step 401: In a case that a time for the target object to move outside the shooting scene is less than or equal to a preset time, when the target object moves to the shooting scene again, the electronic device updates the shooting preview image by using the target object as a focusing object.
Step 402: In a case that a time for the target object to move outside the shooting scene is greater than a preset time, the electronic device updates the shooting preview image by using a third object as a focusing object, where the third object is a shooting object in the shooting preview image.

It should be noted that for a method for re-determining the focusing object and updating the shooting preview image by the electronic device, refer to step 202 and a related solution in the foregoing embodiment. Details are not described herein again.

In this embodiment of this application, the electronic device may determine a length of the time for the target object to move outside the shooting scene, to determine an object on which image processing is performed again. Therefore, in the motion mode, the electronic device can update the shooting preview image based on a motion situation of the target object, to adapt to a composition change situation in the shooting scene in real time, thereby improving an image shooting effect of the electronic device in an AR shooting scene.

It should be noted that, the image processing method provided in the embodiments of this application may be executed by an image processing apparatus, or an electronic device or a function module or an entity in the electronic device. In the embodiments of this application, an example in which the image processing apparatus executes the image processing method is used to describe the image processing apparatus provided in the embodiments of this application.

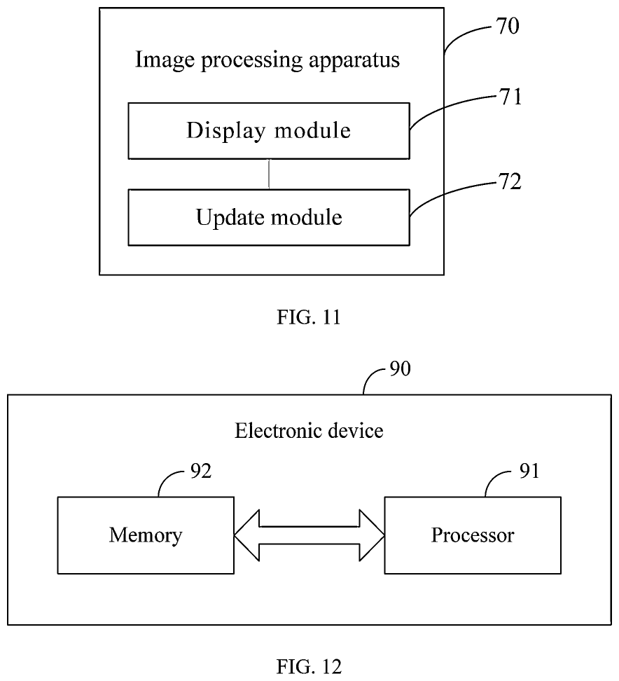

FIG. 11 is a possible schematic structural diagram of an image processing apparatus according to an embodiment of this application. As shown in FIG. 11, the image processing apparatus 70 may include a display module 71 and an update module 72.

The display module 71 is configured to display a shooting preview image, where the shooting preview image includes a first object and a second object, the first object is a virtual shooting object, and the second object is an object in a shooting scene corresponding to the shooting preview image. The update module 72 is configured to update the shooting preview image by using a target object as a focusing object. The target object includes one of the following: the first object and the second object.

In a possible implementation, the update module 72 is configured to: in a case that the second object does not include a preset shooting subject, update the shooting preview image by using the first object as a focusing object; or in a case that the second object includes at least one preset shooting subject, determine the target object from the at least one preset shooting subject and the first object, and update the shooting preview image by using the target object as a focusing object.

In a possible implementation, the update module 72 is configured to: obtain a first feature weight of the first object in the preview image and at least one second feature weight of the at least one preset shooting subject in the preview image; determine a target feature weight from the first feature weight and the at least one second feature weight, where the target weight is not less than the first feature weight and the at least one second feature weight; and determine a shooting object corresponding to the target feature weight as the target object, where the feature weight is used to indicate shooting saliency of a shooting object in the preview image.

In a possible implementation, the target object is the first object, and the update module 72 is configured to: in a case that the first object moves, perform motion focusing on the first object, and update the shooting preview image.

In a possible implementation, the target object is the first object, the first object includes a first virtual object and a second virtual object, and the update module 72 is configured to: in a case that a feature weight of the first virtual object is greater than a feature weight of the second virtual object, perform motion focusing on the first virtual object, and update the shooting preview image, where the feature weight is used to indicate shooting saliency of a shooting object in the preview image.

In a possible implementation, the update module 72 is configured to perform image processing on the shooting preview image by using the target object as a focusing object, to obtain the processed shooting preview image.

In a possible implementation, the update module 72 is configured to perform first image processing on the shooting preview image based on spatial location information of the target object and by using the target object as a focusing object, to obtain the processed shooting preview image.

In a possible implementation, the update module 72 is configured to: in a case that the target object moves, determine a plane location of the target object based on feature information of the target object in the shooting scene and feature information of a shooting object in the shooting preview image; and perform second image processing on the shooting preview image based on the plane location of the target object and first distance information and by using the target object as a focusing object, to obtain the processed shooting preview image, where the first distance information is a distance between a spatial location corresponding to the target object and a camera.

In a possible implementation, after updating the shooting preview image by using the target object as a focusing object, the update module 72 is further configured to: in a case that a time for the target object to move outside the shooting scene is less than or equal to a preset time, when the target object moves to the shooting scene again, update the shooting preview image by using the target object as a focusing object; or in a case that a time for the target object to move outside the shooting scene is greater than a preset time, update the shooting preview image by using a third object as a focusing object, where the third object is a shooting object in the shooting preview image.

This embodiment of this application provides an image processing apparatus. After a first object is added in a shooting scene, the image processing apparatus may select a focusing subject in the shooting scene based on the first object and a preset shooting subject, to re-trigger a focusing and blurring policy so as to generate a better photographing or video effect. That is, after a composition changes due to the addition of the first object, the image processing apparatus performs a refocusing and blurring operation based on a current composition situation, to ensure that an image obtained after the refocusing and blurring operation can meet a shooting requirement of a current scene, so that a focusing or blurring effect of the entire image is improved, thereby improving an effect of an image shot by the image processing apparatus in an AR shooting scene.

The image processing apparatus in this embodiment of this application may be an apparatus, or may be a component, an integrated circuit, or a chip in an electronic device. The apparatus may be a mobile electronic device, or may be a non-mobile electronic device. For example, the mobile electronic device may be a mobile phone, a tablet computer, a notebook computer, a palmtop computer, a vehicle-mounted electronic device, a Mobile Internet Device (MID), an AR/Virtual Reality (VR) device, a robot, a wearable device, an Ultra-Mobile Personal Computer (UMPC), a netbook, a Personal Digital Assistant (PDA), or the like; or may be a server, a Network Attached Storage (NAS), a Personal Computer (PC), a television (TV), a teller machine, a self-service machine, or the like. This is not specifically limited in this embodiment of this application.

The image processing apparatus in this embodiment of this application may be an apparatus with an operating system. The operating system may be an Android operating system, an iOS operating system, or another possible operating system. This is not specifically limited in this embodiment of this application.

The image processing apparatus provided in this embodiment of this application can implement the processes implemented in the foregoing method embodiment. To avoid repetition, details are not described herein again.

For example, as shown in FIG. 12, an embodiment of this application further provides an electronic device 90, including a processor 91, a memory 92, and a program or an instruction that is stored in the memory 92 and that can be run on the processor 91. The program or the instruction is executed by the processor 91 to implement the steps of the foregoing image processing method embodiment, and a same technical effect can be achieved. To avoid repetition, details are not described herein again.

It should be noted that the electronic device in this embodiment of this application includes the mobile electronic device and the non-mobile electronic device.

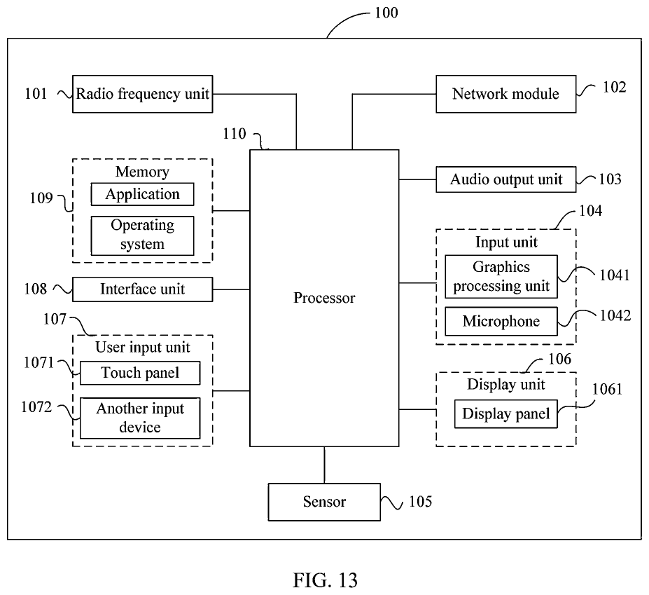

FIG. 13 is a schematic diagram of a hardware structure of an electronic device according to an embodiment of this application.

The electronic device 100 includes but is not limited to components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the electronic device 100 may further include the power supply (for example, a battery) that supplies power to each component. The power supply may be logically connected to the processor 110 by using a power supply management system, so as to manage functions such as charging, discharging, and power consumption by using the power supply management system. The structure of the electronic device shown in FIG. 13 does not constitute a limitation on the electronic device, and the electronic device may include more or fewer components than those shown in the figure, or combine some components, or have different component arrangements. Details are not described herein again.

The display module 106 is configured to display a shooting preview image, where the shooting preview image includes a first object and a second object, the first object is a virtual shooting object, and the second object is an object in a shooting scene corresponding to the shooting preview image.

The processor 110 is configured to update the shooting preview image by using a target object as a focusing object.

According to the electronic device provided in this embodiment of this application, after a first object is added in a shooting scene, the electronic device may select a focusing subject in the shooting scene based on the first object and a preset shooting subject, to re-trigger a focusing and blurring policy so as to generate a better photographing or video effect. That is, after a composition changes due to the addition of the first object, the electronic device performs a refocusing and blurring operation based on a current composition situation, to ensure that an image obtained after the refocusing and blurring operation can meet a shooting requirement of a current scene, so that a focusing or blurring effect of the entire image is improved, thereby improving an effect of shooting an image by the electronic device in an AR shooting scene.

For example, the processor 110 is configured to: in a case that the second object does not include a preset shooting subject, update the shooting preview image by using the first object as a focusing object; or in a case that the second object includes at least one preset shooting subject, determine the target object from the at least one preset shooting subject and the first object, and update the shooting preview image by using the target object as a focusing object.

For example, the processor 110 is configured to: obtain a first feature weight of the first object in the preview image and at least one second feature weight of the at least one preset shooting subject in the preview image; determine a target feature weight from the first feature weight and the at least one second feature weight, where the target weight is not less than the first feature weight and the at least one second feature weight; and determine a shooting object corresponding to the target feature weight as the target object, where the feature weight is used to indicate shooting saliency of a shooting object in the preview image.

For example, the target object is the first object. The processor 110 is configured to: in a case that the first object moves, perform motion focusing on the first object, and update the shooting preview image.

For example, the target object is the first object, and the first object includes a first virtual object and a second virtual object. The processor 110 is configured to: in a case that a feature weight of the first virtual object is greater than a feature weight of the second virtual object, perform motion focusing on the first virtual object, and update the shooting preview image, where the feature weight is used to indicate shooting saliency of a shooting object in the preview image.

For example, the processor 110 is configured to perform image processing on the shooting preview image by using the target object as a focusing object, to obtain the processed shooting preview image.

For example, the processor 110 is configured to perform first image processing on the shooting preview image based on spatial location information of the target object and by using the target object as a focusing object, to obtain the processed shooting preview image.

For example, the processor 110 is configured to: in a case that the target object moves, determine a plane location of the target object based on feature information of the target object in the shooting scene and feature information of a shooting object in the shooting preview image; and perform second image processing on the shooting preview image based on the plane location of the target object and first distance information and by using the target object as a focusing object, to obtain the processed shooting preview image, where the first distance information is a distance between a spatial location corresponding to the target object and a camera.

For example, after updating the shooting preview image by using the target object as a focusing object, the processor 110 is further configured to: in a case that a time for the target object to move outside the shooting scene is less than or equal to a preset time, when the target object moves to the shooting scene again, update the shooting preview image by using the target object as a focusing object; or in a case that a time for the target object to move outside the shooting scene is greater than a preset time, update the shooting preview image by using a third object as a focusing object, where the third object is a shooting object in the shooting preview image.

The electronic device provided in this embodiment of this application can implement the processes implemented in the foregoing method embodiment, and achieve a same technical effect. To avoid repetition, details are not described herein again.

It should be understood that, in this embodiment of this application, the input unit 104 may include a Graphics Processing Unit (GPU) 1041 and a microphone 1042, and the graphics processing unit 1041 processes image data of a still image or a video that is obtained by an image capturing apparatus (for example, a camera) in a video capturing mode or an image capturing mode. The display unit 106 may include a display panel 1061. The display panel 1061 may be configured in a form such as a liquid crystal display or an organic light-emitting diode. The user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

The memory 109 may be configured to store a software program and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 109 in this embodiment of this application includes but is not limited to these memories and a memory of any other proper type.

The processor 110 may include one or more processing units. For example, an application processor and a modem processor are integrated into the processor 110. The application processor mainly processes an operating system, a user interface, an application, and the like. The modem processor mainly processes a wireless communication signal, for example, a baseband processor. It can be understood that, in some embodiments, the modem processor may not be integrated into the processor 110.

An embodiment of this application further provides a readable storage medium. The readable storage medium stores a program or an instruction, and the program or the instruction is executed by a processor to implement the processes of the foregoing method embodiment, and a same technical effect can be achieved. To avoid repetition, details are not described herein again.

The processor is a processor in the electronic device in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application provides a computer program product. The program product is stored in a storage medium. The program product is executed by at least one processor to implement the processes of the foregoing image processing method embodiment, and a same technical effect can be achieved. To avoid repetition, details are not described herein again.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. An image processing method, comprising:
displaying a shooting preview image, wherein the shooting preview image comprises a first object and a second object, the first object is a virtual shooting object, and the second object is an object in a shooting scene corresponding to the shooting preview image; and
updating the shooting preview image by using a target object as a focusing object, wherein the target object is the first object or the second object.

2. The method according to claim 1, wherein the updating the shooting preview image by using the target object as the focusing object comprises:
when the second object does not comprise a preset shooting subject, updating the shooting preview image by using the first object as the focusing object; or
when the second object comprises at least one preset shooting subject, determining the target object from the at least one preset shooting subject or the first object, and updating the shooting preview image by using the target object as the focusing object.

3. The method according to claim 2, wherein the determining the target object from the at least one preset shooting subject or the first object comprises:
obtaining a first feature weight of the first object in the preview image and at least one second feature weight of the at least one preset shooting subject in the preview image;
determining a target feature weight from the first feature weight and the at least one second feature weight, wherein the target weight is not less than the first feature weight and the at least one second feature weight; and
determining a shooting object corresponding to the target feature weight as the target object, wherein
the feature weight is used to indicate shooting saliency of a shooting object in the preview image.

4. The method according to claim 1, wherein the target object is the first object, and the updating the shooting preview image by using the target object as the focusing object comprises:
when the first object moves, performing motion focusing on the first object, and updating the shooting preview image.

5. The method according to claim 1, wherein the target object is the first object, the first object comprises a first virtual object and a second virtual object, and the updating the shooting preview image by using the target object as the focusing object comprises:
when a feature weight of the first virtual object is greater than a feature weight of the second virtual object, performing motion focusing on the first virtual object, and updating the shooting preview image, wherein
the feature weight is used to indicate shooting saliency of a shooting object in the preview image.

6. The method according to claim 1, wherein the updating the shooting preview image by using the target object as the focusing object comprises:
performing image processing on the shooting preview image by using the target object as the focusing object, to obtain the processed shooting preview image.

7. The method according to claim 6, wherein the performing image processing on the shooting preview image by using the target object as the focusing object, to obtain the processed shooting preview image comprises:
performing first image processing on the shooting preview image based on spatial location information of the target object and by using the target object as the focusing object, to obtain the processed shooting preview image.

8. The method according to claim 6, wherein the performing image processing on the shooting preview image by using the target object as the focusing object, to obtain the processed shooting preview image comprises:
when the target object moves, determining a plane location of the target object based on feature information of the target object in the shooting scene and feature information of a shooting object in the shooting preview image; and
performing second image processing on the shooting preview image based on the plane location of the target object and first distance information and by using the target object as the focusing object, to obtain the processed shooting preview image, wherein the first distance information is a distance between a spatial location corresponding to the target object and a camera.

9. The method according to claim 1, wherein after the updating the shooting preview image by using the target object as the focusing object, the method further comprises:
in response to a time for the target object to move outside the shooting scene is less than or equal to a preset time, updating the shooting preview image by using the target object as the focusing object when the target object moves to the shooting scene again; or
in response to a time for the target object to move outside the shooting scene is greater than a preset time, updating the shooting preview image by using a third object as the focusing object, wherein the third object is a shooting object in the shooting preview image.

10. An electronic device, comprising a processor and a memory storing instructions, wherein the instructions, when executed by the processor, cause the processor to perform operations comprising:
displaying a shooting preview image, wherein the shooting preview image comprises a first object and a second object, the first object is a virtual shooting object, and the second object is an object in a shooting scene corresponding to the shooting preview image; and
updating the shooting preview image by using a target object as a focusing object, wherein the target object is the first object or the second object.

11. The electronic device according to claim 10, wherein the updating the shooting preview image by using the target object as the focusing object comprises:
when the second object does not comprise a preset shooting subject, updating the shooting preview image by using the first object as the focusing object; or
when the second object comprises at least one preset shooting subject, determining the target object from the at least one preset shooting subject or the first object, and updating the shooting preview image by using the target object as the focusing object.

12. The electronic device according to claim 11, wherein the determining the target object from the at least one preset shooting subject or the first object comprises:
obtaining a first feature weight of the first object in the preview image and at least one second feature weight of the at least one preset shooting subject in the preview image;
determining a target feature weight from the first feature weight and the at least one second feature weight, wherein the target weight is not less than the first feature weight and the at least one second feature weight; and
determining a shooting object corresponding to the target feature weight as the target object, wherein
the feature weight is used to indicate shooting saliency of a shooting object in the preview image.

13. The electronic device according to claim 10, wherein the target object is the first object, and the updating the shooting preview image by using the target object as the focusing object comprises:
when the first object moves, performing motion focusing on the first object, and updating the shooting preview image.

14. The electronic device according to claim 10, wherein the target object is the first object, the first object comprises a first virtual object and a second virtual object, and the updating the shooting preview image by using the target object as the focusing object comprises:
when a feature weight of the first virtual object is greater than a feature weight of the second virtual object, performing motion focusing on the first virtual object, and updating the shooting preview image, wherein
the feature weight is used to indicate shooting saliency of a shooting object in the preview image.

15. The electronic device according to claim 10, wherein the updating the shooting preview image by using the target object as the focusing object comprises:
performing image processing on the shooting preview image by using the target object as the focusing object, to obtain the processed shooting preview image.

16. The electronic device according to claim 15, wherein the performing image processing on the shooting preview image by using the target object as the focusing object, to obtain the processed shooting preview image comprises:
performing first image processing on the shooting preview image based on spatial location information of the target object and by using the target object as the focusing object, to obtain the processed shooting preview image.

17. The electronic device according to claim 15, wherein the performing image processing on the shooting preview image by using the target object as the focusing object, to obtain the processed shooting preview image comprises:
when the target object moves, determining a plane location of the target object based on feature information of the target object in the shooting scene and feature information of a shooting object in the shooting preview image; and
performing second image processing on the shooting preview image based on the plane location of the target object and first distance information and by using the target object as the focusing object, to obtain the processed shooting preview image, wherein the first distance information is a distance between a spatial location corresponding to the target object and a camera.

18. The electronic device according to claim 10, wherein after the updating the shooting preview image by using the target object as the focusing object, the instructions, when executed by the processor, cause the processor to further perform operations comprising:
in response to a time for the target object to move outside the shooting scene is less than or equal to a preset time, updating the shooting preview image by using the target object as the focusing object when the target object moves to the shooting scene again; or
in response to a time for the target object to move outside the shooting scene is greater than a preset time, updating the shooting preview image by using a third object as the focusing object, wherein the third object is a shooting object in the shooting preview image.

19. A non-transitory computer readable storage medium storing instructions, that, when executed by a processor, cause the processor to perform operations comprising:
displaying a shooting preview image, wherein the shooting preview image comprises a first object and a second object, the first object is a virtual shooting object, and the second object is an object in a shooting scene corresponding to the shooting preview image; and
updating the shooting preview image by using a target object as a focusing object, wherein the target object is the first object or the second object.

20. The non-transitory computer readable storage medium according to claim 19, wherein the updating the shooting preview image by using the target object as the focusing object comprises:
when the second object does not comprise a preset shooting subject, updating the shooting preview image by using the first object as the focusing object; or
when the second object comprises at least one preset shooting subject, determining the target object from the at least one preset shooting subject or the first object, and updating the shooting preview image by using the target object as the focusing object.
